(19) United States
(12) Patent Application Publication
(10) Pub. No.: US 2021/0352573 A1
(43) Pub. Date: Nov. 11, 2021

(54) Carrier Switching with Network Scanning

(71) Applicant: Google LLC, Mountain View, CA (US)

(72) Inventors: Myra Nam, Sunnyvale, CA (US); Brian Williammee, Palo Alto, CA (US); Xinruo Sun, Sunnyvale, CA (US); Xuan Zheng, San Jose, CA (US); Austin Small, San Francisco, CA (US); Ziyi Jin, Kitchener (CA); Nathan Harold, Sunnyvale, CA (US); Ying Xu, Campbell, CA (US)

(21) Appl. No.: 16/952,781

(22) Filed: Nov. 19, 2020

Related U.S. Application Data
(60) Provisional application No. 63/020,751, filed on May 6, 2020.

(51) Int. Cl. H04W 48/16; H04W 36/30; H04W 24/02

(52) U.S. Cl. CPC H04W 48/16; H04W 24/02; H04W 36/30

(57) ABSTRACT

A network scan may be performed, and the best network may be selected in real time in the device after evaluating all available carriers whose network information is gathered by network scanning The network scan enables the device to fairly compare the connectivity of the available carrier services and can be used to improve the on-device network selection. The network scan may be further used in order to ensure the existence of a better carrier service before switching. Accordingly, this may reduce unnecessary poor switches to networks having lower quality connections and increase good switches to networks having better quality. The present disclosure provides for determining when to run network scan and how to use the scan results to make the cell network selection decision.

### CROSS-REFERENCE TO RELATED APPLICATIONS

The present application claims the benefit of the filing date of U.S. Provisional Patent Application No. 63/020,751 filed May 6, 2020, the disclosure of which is hereby incorporated herein by reference.

### BACKGROUND

Mobile devices typically communicate over a wireless network using one or more carriers. However, while the mobile device may be utilizing a first carrier, with a mediocre or low quality connection, other carriers may be available. The mobile device, however, is unaware of whether switching to another carrier would result in a better quality connection.

Network scanning is a capability to scan the networks of various carrier services without connecting to them. Current carrier switching in a single SIM comes with a high cost, for example, high battery consumption and data loss during the switch. In addition, the device has limited information about the current carrier but not others.

Additionally, if the mobile device could compare quality of one carrier to another, it would need an appropriate parameter quantifying quality measurements. A symbol including a series of bars of increasing height is often used as an indicator of signal strength for a network connection by a mobile device. However, there is no industry standard that ties cell phone signal strength to cell phone bars.

### BRIEF SUMMARY

The present disclosure provides for determining when to perform a network scan to identify other carriers with potentially better quality connections. Moreover, the disclosure provides a mechanism for accurately determining quality of connections over the other potential carriers using throughput measurements. Real-time carrier exploration ensures that a mobile device finds the carrier that provides the best connectivity, for example via a connectivity comparison and validation across available carriers. According to some examples, the mobile device may automatically obtain the connectivity states of available carriers all the time, not just when connectivity is poor.

One aspect of the disclosure provides a method of determining whether to perform a scan of carriers available for connection to a user equipment (UE). The method includes determining a network connection quality for carrier connection between the UE and a first communication carrier, predicting, based on aggregated throughput information for connections between one or more UEs and a variety of carriers, whether a second carrier has better connection quality than the first communication carrier, and determining whether to perform a carrier scan based on at least one of the determined connection quality for the first communication carrier and the predicted connection quality for the second carrier. The connection quality for the first communication carrier may be computed based on at least one of signal strength or throughput of applications executed by the UE over the first communication carrier. According to some examples the method may further include identifying the second carrier as a target for switching, identifying a target network type of the second carrier, and comparing the target network type of the second network to a current network type of the first carrier, wherein the determining whether to perform the carrier scan is further based on at least one of the target network type or the current network type.

According to some examples, the method may further include scheduling carrier scans to be performed at predetermined intervals. In such examples, determining whether to perform the carrier scan may be further based on timing of a next scheduled scan. When the next scheduled scan is scheduled within a predetermined time period, the next scheduled scan may be canceled and a new scan may be initiated.

Another aspect of the disclosure provides for a system for determining whether to perform a scan of carriers available for connection to a user equipment (UE). The system includes a memory, a communication interface, and one or more processors in communication with the memory and the communication interface. The one or more processors may be configured to determine a network connection quality for a carrier connection between the UE and a first communication carrier, predict, based on aggregated throughput information for connections between one or more UEs and a variety of carriers, whether a second carrier has better connection quality than the first communication carrier, and determine whether to perform a carrier scan based on at least one of the determined connection quality for the first communication carrier and the predicted connection quality for the second carrier.

Yet another aspect of the disclosure provides a computer-readable medium storing instructions executable by one or more processors for performing a method of determining whether to switch a carrier connection of UE with a first communication carrier to a second communication carrier, the method including determining a network connection quality for carrier connection between the UE and a first communication carrier, predicting, based on aggregated throughput information for connections between one or more UEs and a variety of carriers, whether a second carrier has better connection quality than the first communication carrier, and determining whether to perform a carrier scan based on at least one of the determined connection quality for the first communication carrier and the predicted connection quality for the second carrier.

### BRIEF DESCRIPTION OF THE DRAWINGS

FIG. 1 is a pictorial diagram of a system according to aspects of the disclosure.

FIG. 2 is a block diagram of an example user equipment (UE) according to aspects of the disclosure.

FIG. 3 is a block diagram of an example server according to aspects of the disclosure.

FIG. 4 is an example data structure including collected network connectivity information according to aspects of the disclosure.

FIG. 5 is an example flow diagram for multiple scan requests according to aspects of the disclosure.

FIG. 6 is a flow diagram illustrating an example of locking according to aspects of the disclosure.

FIG. 7 is a flow diagram illustrating an example of requesting a scan according to aspects of the disclosure.

FIG. 8 is a flow diagram illustrating an example of canceling a scan according to aspects of the disclosure.

FIG. 9 is a flow diagram illustrating an example of when to scan for potential carriers for switching according to aspects of the disclosure.

### DETAILED DESCRIPTION

A network scan may be performed, and the best network may be selected in real time in the device after evaluating all available carriers whose network information is gathered by network scanning. The network scan enables the device to fairly compare the connectivity of the available carrier services and can be used to improve the on-device network selection. The network scan may be further used in order to ensure the existence of a better carrier service before switching. Accordingly, this may reduce unnecessary poor switches to networks having lower quality connections and increase good switches to networks having better quality. The present disclosure provides for determining when to run network scan and how to use the scan results to make the cell network selection decision.

### Example Systems:

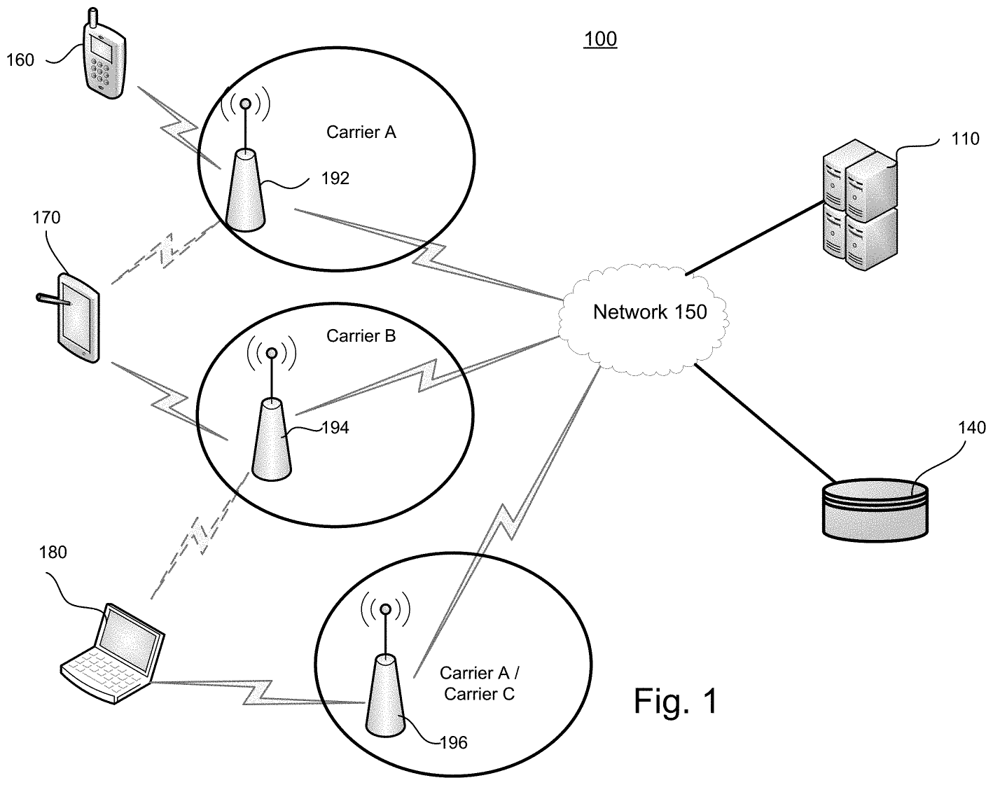

FIG. 1 illustrates an example system 100 including computing devices for performing aspects of the present disclosure. The system 100 includes various user equipment (UEs) 160, 170, 180, such as client computing devices, communicatively coupled to a server computing device 110 through a network 150. The UEs 160-180 are further each coupled to one or more access points 192-196. In some examples, a given UE may communicate with multiple access points 192-196 at a given time. In other examples, the UEs communicate with one access point at a time, though other potential connections (shown in dashed lines) are available. For example, while UE 170 is connected through access point 194 on Carrier B, UE 170 is within range of access point 192 and could potentially connect to the network 150 through Carrier A.

Access points 192-194 may each provide connectivity for the UEs 160-180 to the network 150. For example, each of the UEs 160-180 may be connected to one or more of the access points 192-194. The connectivity provided by each access point 192-196 may be provided through one or more carriers, such as telecommunications service providers (e.g., Verizon, AT&T, Sprint, etc.). For example, each access point may be owned and operated by one carrier, though the carrier may lease use of its owned access points to other carriers. As shown in FIG. 1, for example, access point 192 is owned and operated by Carrier A and provides connectivity through Carrier A alone. Access point 194 is owned and operated by Carrier B. Access points 196 provides connectivity through multiple carriers, Carrier A and Carrier C.

Each of the computing devices 110, 160, 170 can be at different nodes of a network 150 and capable of directly and indirectly communicating with other nodes of network 150. Although only a few computing devices are depicted in FIG. 1, it should be appreciated that a typical system can include a large number of connected computing devices, with each different computing device being at a different node of the network 150.

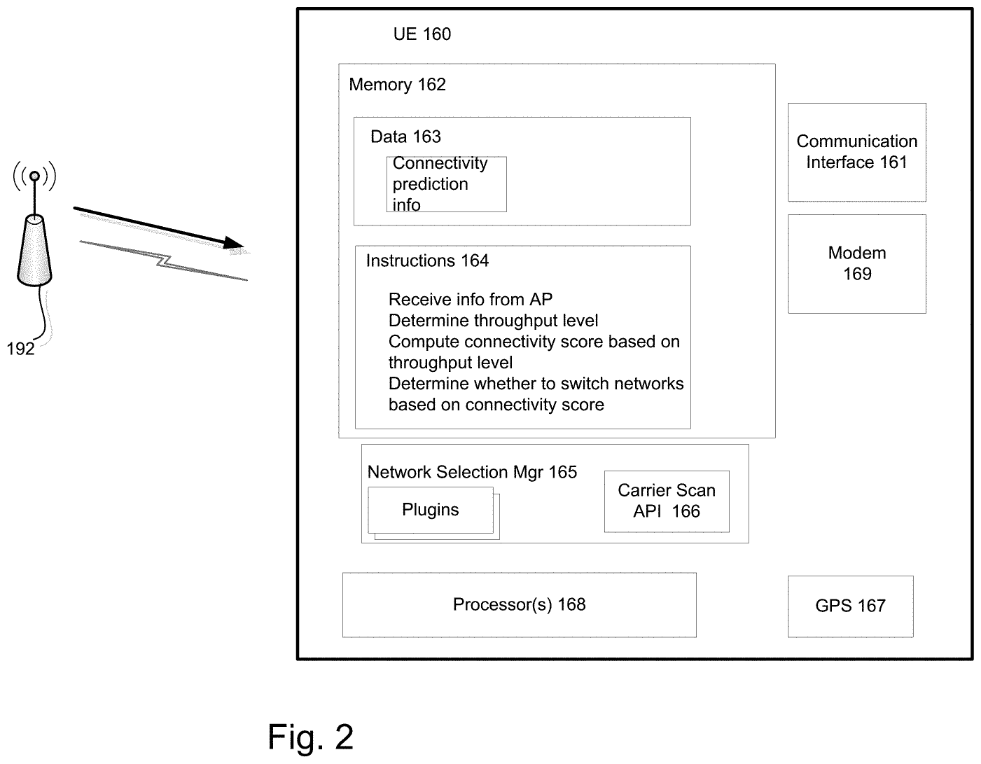

The UEs 160, 170, 180 may include any of a variety of types of devices capable of capturing images and communicating over a network. By way of example and not limitation, such devices may include smartphones, cameras with wireless network access, laptops, smartwatches, tablets, head-mounted displays, gaming systems, etc. The client computing devices are described in further detail in connection with FIG. 2 below.

The network 150 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. The network 150 may be, for example, a LAN, WAN, the Internet, etc. According to some examples, the network 150 may include multiple sub-networks with infrastructure operated by different carriers. Although certain advantages are obtained when information is transmitted or received as noted above, other aspects of the subject matter described herein are not limited to any particular manner of transmission of information.

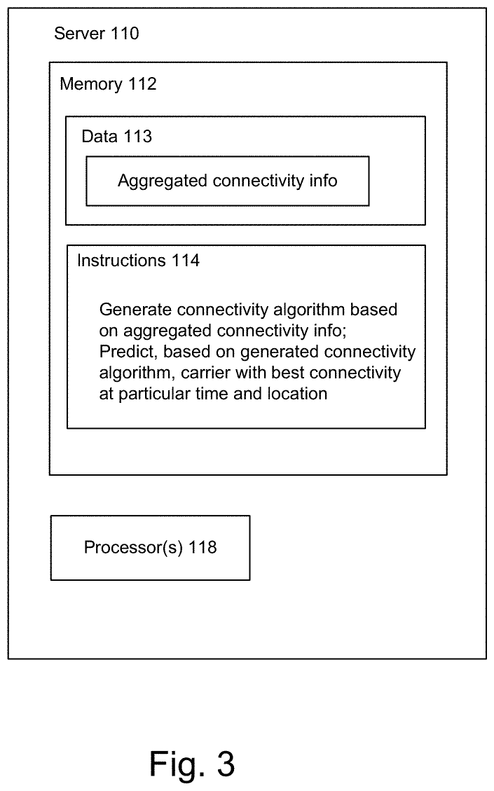

The server computing device 110 may actually include a plurality of processing devices in communication with one another. The server computing device 110 is described in further detail in connection with FIG. 3 below.

Databases 140 may be accessible by the server 110 and UEs 160, 170, 180. The databases 140 may include, for example, a collection of connectivity information from a plurality of UEs over a time period. For example, the database 140 may store aggregated information indicating a carrier, time, location, and connection quality. The connection quality may be indicated in any of a number of ways, such as throughput, signal strength, etc. Databases 140 may in some examples include a distributed storage system where data is stored on a plurality of different storage devices which may be physically located at the same or different geographic locations. Databases 140 may be connected to the computing devices via the network 150 as shown in FIG. 1 and/or may be directly connected to any of the computing devices 110.

FIGS. 2 and 3 illustrate further details of components in the example system 100. It should not be considered as limiting the scope of the disclosure or usefulness of the features described herein.

FIG. 2 illustrates an example of components in the UE 160. UE 160 may be a personal computing device intended for use by a user, and have all of the components normally used in connection with a personal computing device such as a processor 168, memory 162 storing data 163 and instructions 164, a communication interface 161, a modem 169, a display, and user input. The UE 160 may also include a camera, speakers, a network interface device, and all of the components used for connecting these elements to one another. The UE 160 may also include a location determination system, such as a GPS 167. Other examples of location determination systems may determine location based on wireless access signal strength, images of geographic objects such as landmarks, semantic indicators such as light or noise level, etc.

Although the UEs 160, 170 may each comprise a full-sized personal computing device, they may alternatively comprise mobile computing devices capable of wirelessly exchanging data with a server over a network such as the Internet. By way of example only, UE 160 may be a mobile phone or a device such as a wireless-enabled PDA, a tablet PC, a netbook, a smart watch, a head-mounted computing system, or any other device that is capable of obtaining information via the Internet. As an example the user may input information using a small keyboard, a keypad, microphone, using visual signals with a camera, or a touch screen.

Memory 162 can also include data 163 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 164 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 163 may be retrieved, stored or modified by the one or more processors 168 in accordance with the instructions 164. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 168 can be any conventional processors, such as a commercially available CPU. Alternatively, the processors can be dedicated components such as an application specific integrated circuit (“ASIC”) or other hardware-based processor. Although not necessary, the UE 160 may include specialized hardware components to perform specific computing processes, such as throughput measurement, computation of connectivity scores, etc.

The UE 160 may also include a network selection manager 165, which may further include one or more plugins and a carrier scan application program interface (API) 166. The one or more plugins may detect information used by the carrier scan API 166 for determining when to initiate a network scan. For example, a first plugin may detect poor network connectivity conditions, and suggest a carrier switch to the carrier scan API 166 and/or the network selection manager 165. A second plugin may utilize crowdsourced throughput data to suggest a best network in a given location. While these are merely a couple examples, it should be understood that any number of plugins may be included to suggest carrier scans or switching based on a variety of information. Moreover, while described herein as plugins, various other implementations are possible. The carrier API 166 may further schedule carrier scans, such as through a job scheduler. Operations of the carrier API 166 are discussed in further detail herein.

The UE 160 may receive information from one or more access points 192, as shown in FIG. 2. Such information may be used by the UE 160 to determine throughput. Such information may include, for example, the carrier servicing the UE, signal strength, connection speed, etc. Based on the received information, the UE 160 may compute a connectivity score indicating a quality of its connection over the carrier servicing the UE. Based on the connectivity score, the UE 160 may determine whether to request a scan to discover other networks with potentially better connectivity. For example, the scan may be requested if the connectivity score is below a predetermined threshold, if a scan is not already scheduled, or if any of a variety of other conditions or combinations of conditions are met. The UE 160 may use the results of a new scan or a previously stored scan to determine whether to switch carriers. For example, the UE 160 may compare connectivity information for other carriers indicated in the scan to the computed connectivity score.

FIG. 3 illustrates an example server 110. Each of the server computing devices 110 can contain one or more processors 118, memory 112 and other components typically present in general purpose computing devices. Memory 112 can store information accessible by the one or more processors 118, including instructions 114 that can be executed by the one or more processors 118.

Memory 112 can also include data 113 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 114 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 113 may be retrieved, stored or modified by the one or more processors 220 in accordance with the instructions 114. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 118 can be any conventional processors, such as a commercially available CPU. Alternatively, the processors can be dedicated components such as an application specific integrated circuit (“ASIC”) or other hardware-based processor. Although not necessary, one or more of computing devices 110 may include specialized hardware components to perform specific computing processes, such as image matching, image editing, object recognition, or performing other processes faster or more efficiently.

Although FIG. 3 functionally illustrates the processor, memory, and other elements of computing device 110 as being within the same block, the processor, computer, computing device, or memory can actually comprise multiple processors, computers, computing devices, or memories that may or may not be stored within the same physical housing. For example, the memory can be a hard drive or other storage media located in housings different from that of the computing devices 110. Accordingly, references to a processor, computer, computing device, or memory will be understood to include references to a collection of processors, computers, computing devices, or memories that may or may not operate in parallel. For example, the computing devices 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 150.

The one or more processors 118 may perform one or more operations for collecting and aggregating connectivity information from one or more UEs, generating a connectivity model based on the aggregated connectivity information, and predicting which carrier will provide optimal connectivity under selected conditions, such as a predetermined time, location, etc.

Signal strength may be used to correctly measure the quality of the cell connectivity. However, different technology and frequency may require different measurements. For example, for LTE, measurement fields may include bandwidth, cell connection status, reference signals received power (RSRP), reference signal received quality (RSRQ), and estimated throughput of various applications, such as search engine applications, video streaming applications, etc. Accordingly, various features from the signal strength (e.g., rsrp, rsrq, bandwidth, frequency, cell connection status, etc.) may be collected or various carriers. Given the signal strength value, machine intelligence may predict the cell connectivity. Machine-intelligence may automatically learn to predict the cell connectivity in the throughput units given the observed signal strength.

The throughput and signal strength information is aggregated in the database 140. This may be used by the UE 160 as an additional information if the signal strength is not detected by the UE 160. For example, such aggregated connectivity information may be utilized by one of the plugins of the network selection manager 165 of the UE 160 in determining whether to perform a network scan.

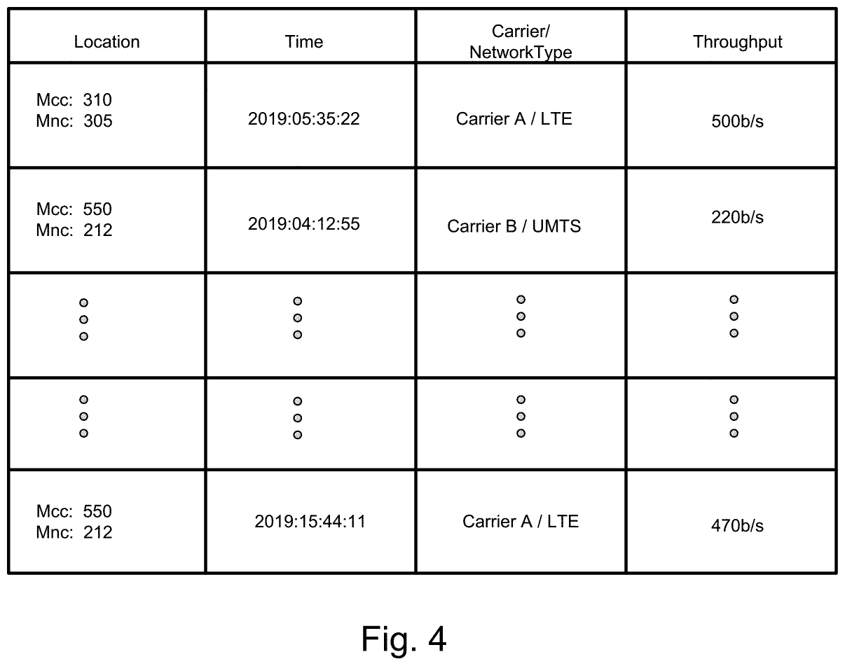

FIG. 4 illustrates an example of collected connectivity information for multiple carriers. According to the example shown, such information include location, time, carrier and network type, and throughput. It should be understood that any of a variety of other information may be included. For example, connection quality may be indicated using any of a variety of other measurements in addition to or in the alternative to throughput. Moreover, while only a few entries are shown, it should be understood that numerous entries may be aggregated. Even further, the information may be presented in any of a variety of data structures, and sorted or categorized in any of a number of ways.

### Example Carrier Scanning Methods:

Carrier scans can be scheduled by a job scheduler at the UE, or requested by one more software modules, plugins, or other executables of the UE. The scan may search for an evaluate various types of radio access networks, such as GERAN (GSM/EDGE), UTRAN (UMTS/HSPA), EutranBands (LTE), etc. The scanning may be performed periodically, or only once when requested. According to some examples, multiple scan requests from multiple requesters, such as multiple different plugins, may be gathered and serviced by a carrier scan service executed at the UE in by a single scan. According to some examples, can use locking mechanism to prevent multiple scans at the same time. According to other examples, multiple requests for scans may be merged into a single scan.

According to a first example scan method, upon receiving the scan requests, independent job components are created for each request and the job scheduler schedules scan jobs. For example, a serial task executor may run scheduled scan jobs in serial so that no two scan jobs are using the modem at the same time.

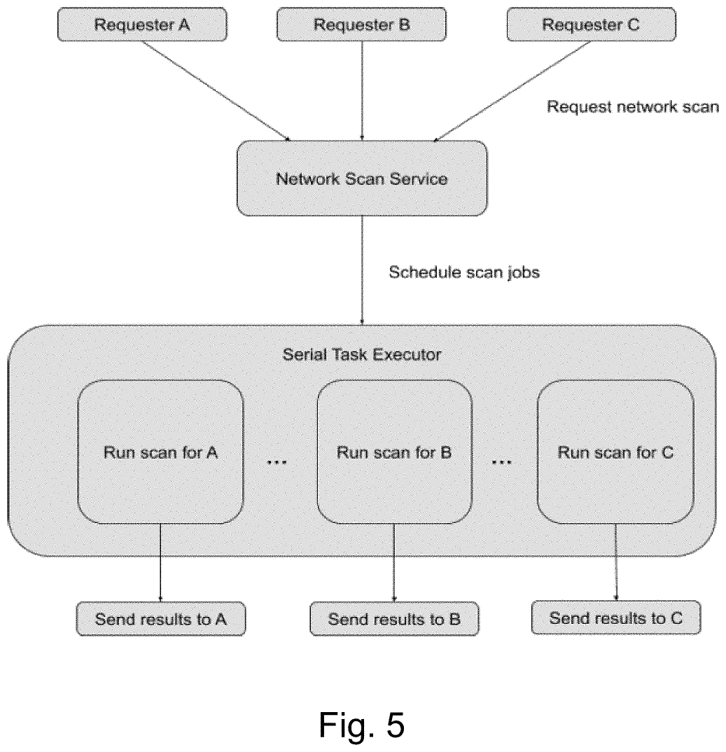

FIG. 5 illustrates an example workflow for multiple scan requests. As shown, Requesters A, B, and C may issue scan requests to a scan service. The requests may include, for example, an identifier for the requester and target carriers to be scanned. The Requesters A, B, C may be, for example, different software modules, plugins, extension, etc. that interface an application programming interface (API). The network scan service is executed at the UE to capture the real-time connectivity of the carrier service. The scan service schedules scan jobs. For example, the scan job for each requester may be scheduled serially. A scan may be considered successful if all or at least one of the target carriers were found. According to some examples, the criteria for determining a successful scan may be defined by the requester. The results of the scans may be sent to the respective requesters. According to some examples, the scan results may be logged for future analysis.

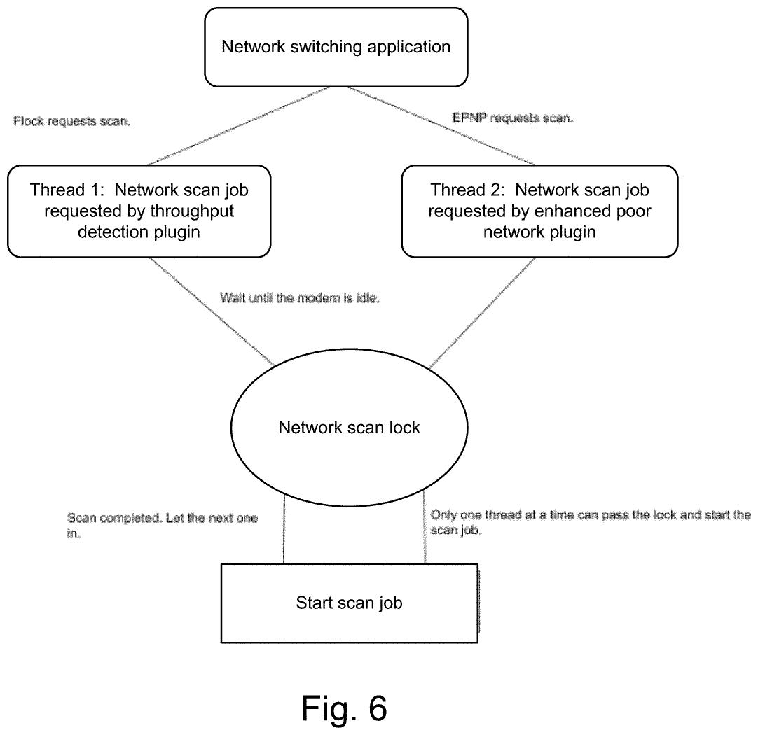

A second example scan method, illustrated in FIG. 6, may include thread safe scan with locking. Different job IDs may be assigned to different scan requesters, and the job scheduler will create two different threads for their scan jobs. For example, as shown in FIG. 6, a first thread is created for a first requester, and a second thread is created for a second requester. A lock object is created in and a boolean flag indicates if a scan is currently running. Each thread has to acquire the lock to check or toggle the flag before calling the network scan API. Once a thread has acquired the lock, it will check the flag condition. If the flag is false (i.e., no scan is running), it will set the flag to true, release the lock and start the network scan job. If the flag the true (i.e., a scan is running), the thread waits on the lock. After a network scan completed, the flag is set back to false. Threads that are waiting on the lock may be called to wake up.

A third example scan method provides for thread safe scans that merge multiple requests. If multiple switching plugins request the carrier scan, the scan service provider merges the requests, schedules a single carrier scan, and returns the results to each scan requester. If one requester cancels the scan, it will not receive the scan results starting at the next scan cycle, but the scan can keep running for other scan requesters.

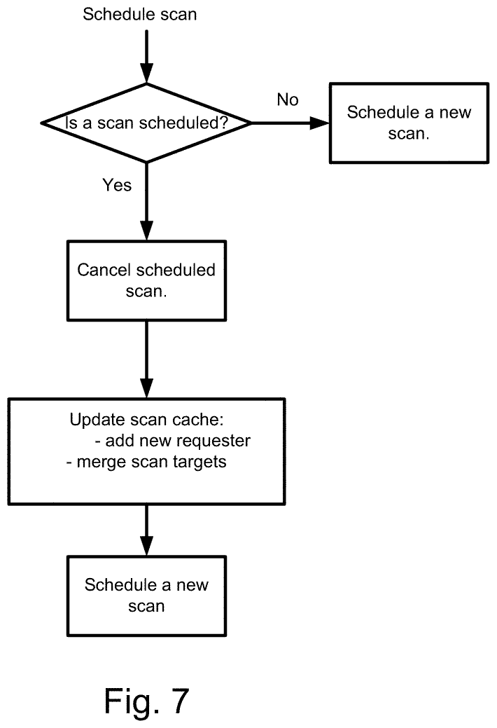

FIG. 7 provides for scheduling the scan when requested according to this third example scan method. When a new scan is requested, it is determined whether a scan is scheduled. If not, the new scan is scheduled. If a scan is already scheduled, it is canceled. A scan cache is updated to add a new requester and merge scan targets. The network scan job running in background will then retrieve this information from cache when a new scan cycle starts. Then a new scan job is scheduled. The network scan service will notify a plugin by a running a switching controller event if at least one of its requested target carrier network is found.

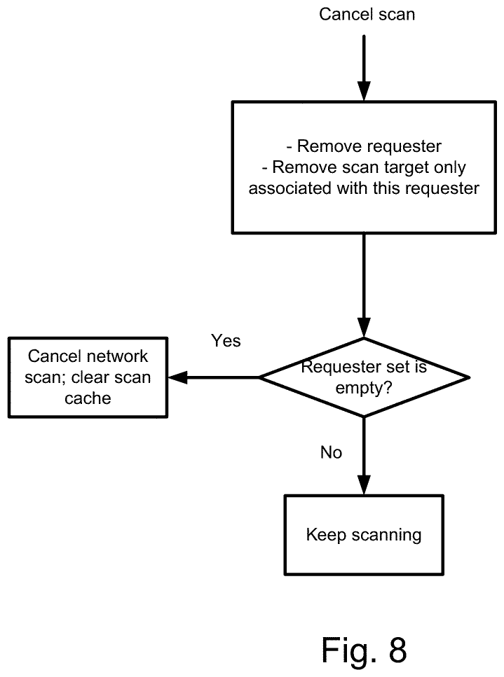

FIG. 8 provides for canceling a scan. The cancel method will cancel a background network scan run for this requester but can keep the scan running for other scan requesters. For example, the method removes the requester that canceled the scan, and removes any scan targets associate with the requester. If there are no other requesters, the scan is canceled and the scan cache is cleared. However, if other requesters have requested scans that have not been canceled, the scan will continue for those requesters.

Both plugins and background running scans may cancel a network scan. Plugins may cancel the scan when the scan is no longer needed or they want to clear the previous scheduled scan and request a new one. The background scan may cancel the scan running for a requester and update the scan cache upon scan success or partial success. It is possible that one thread calls to schedule the scan and the other thread calls to cancel the scan. It is further possible that two threads call to cancel a scan at the same time. According to some examples, such operations may be synchronized.

### Perform Network Scan to Prevent Switching to Lower Quality Network:

The network scan API provides real-time visibility to carrier network quality without breaking a current connection between a UE and a carrier network. The network scan API may accept parameters such as radio access network, band, and channel.

The results of the API may be a list of objects indicating, for example, location, time, signal strength etc. Location may be indicated by, for example, mobile country code (Mcc) and/or mobile network code (Mnc). Signal strength may be indicated by, for example, throughput, reference signals received power (RSRP), reference signal received quality (RSRQ), or any of a variety of other measurements. The scan results may be cached for the location and used again for subsequent requests close in time to the initial request. According to some examples, a geofence may be set up once a scan is complete, and another scan may be performed only when a geofence transition event occurs.

In some instances, a network selection manager of the UE may propose a switch from an LTE carrier network to a non-LTE carrier network. The switch may be proposed, for example, by a plugin based on crowdsourced throughput data for a location of the UE. When such a switch is proposed, or when any switch is proposed from an LTE network, a scan may be performed to evaluate the target carrier. Such evaluation may include determining whether the target carrier has an LTE network.

The scan may be performed in an asynchronous service. If the target carrier has an LTE network, the switch may be allowed. Otherwise, another scan may be scheduled in twice of a default interval time. For example, if the default interval is 5 minutes, the next scan will take place in 10 minutes if the previous scan result does not have LTE. If the geofence transition is triggered, the suggested carrier of the current location might be different than before. In this case, the scheduled scan may be canceled. A new scan may be run if the plugin again suggests to switch in this new geofence.

The network scan result may be logged for future analysis. The log may list, for each scan, information about one specific network, including what the target network type is (LTE, UMTS, CDMA, etc.), what the target carrier is and whether it is found, and the signal strength of each network. The status of the scan may also be recorded, such as success with all targets found, failure due to modem is busy with other task, failure due to timeout, etc. The log entry may also contain information about the start and end timestamp, thereby providing scan latency data.

### When Poor Network is Detected, Perform Network Scan to Ensure Good Switching Landing on Better Network:

According to some examples, a carrier switch may be proposed, such as by a plugin, when performance or connection quality over a carrier currently utilized by the UE is insufficient. The performance/connection quality may be considered insufficient if it falls below a threshold level, or if it is suspected that a better quality connection is available over a different carrier. The results of the carrier scan API may be used to suggest uniform integrated circuit card (UICC) profile-switching between carrier profiles on the UE's subscriber identity module (SIM) card.

A frequency with which scans are performed may balance good switching decisions with costs such as battery life and temporary network disconnect. According to one example, locks may be used to restrict the number of times that the network scan or switching action can be scheduled. For example, a plugin may not request to schedule a new network scan or suggest a new switch if one or more of the locks are active. According to some examples, one or more of several different types of locks may be applied. A location lock may be set active after each successful switching or a fall back switching. It can be unlocked after lasting for its predefined locking time or leaving the current geofence. A time lock may be set active after each successful switching or a fall back switching. It can be unlocked after lasting for desired time period. According to some examples, the location lock and/or the time lock may prevent scanning but not switching. A time-to-wait lock may be held for the time to wait on the current network before the plugin can schedule a potential switch or network scan.

An exponential backoff periodic scan may be scheduled and kept running until it successfully finds the target network. The scan success criteria is that the scan found at least one target requested by the plugin. The scan may be canceled if there is a scan target change and rescheduled if necessary. The scan may also be canceled if there is a change in the radio access technology (RAT) currently utilized by the UE at the time of the scheduled scan. Because the scan is looking for carriers with higher RAT ratings than the current one, if the current RAT changes, the scan target should be updated.

After receiving the scan results about the available LTE networks at the current location, the network selection manager may make switching decisions based on the scan results, switching policy, and the connectivity score for the current carrier and the target carrier.

In some instances, such as if a new scan is not scheduled, switching decisions may be made using stored results. For example, the UE may hold recent network scan results to predict the best carrier at the current moment and the near future. If the network selection manager decides to switch, it may also update the corresponding scan results using current network situation data.

Learning when to Schedule Network Scans Using Reinforcement Learning:

Connectivity states may be obtained from other carriers in a number of ways. Network scan and speed tests may be used to obtain real-time connectivity states. A network scan detects connectivity states of other carriers without switching the UE to the other carriers. The results may indicate a network type and signal strength. Speed tests may require switching to the other carrier for x seconds and performing speed tests. The results may indicate throughput, network type, network capabilities, etc.

Data may be collected using random sampling to trigger network scan or speed test on other carriers. If a better network is found, the network selection manager may determine to switch to the best available carrier. The random sampling may be performed, for example, using greedy sampling based on uniform distribution, or by learning when to explore the new carriers and exploit the obtained information with Bayesian assumption.

Connectivity should matter more when users are actively using data. Accordingly, random-sample may be used to collect data when users are on-screen or using data. In addition, if last observed states are available and not out-of-date, those states may be used in determining network switching rather than performing a new scan or speed test.

### Example Method:

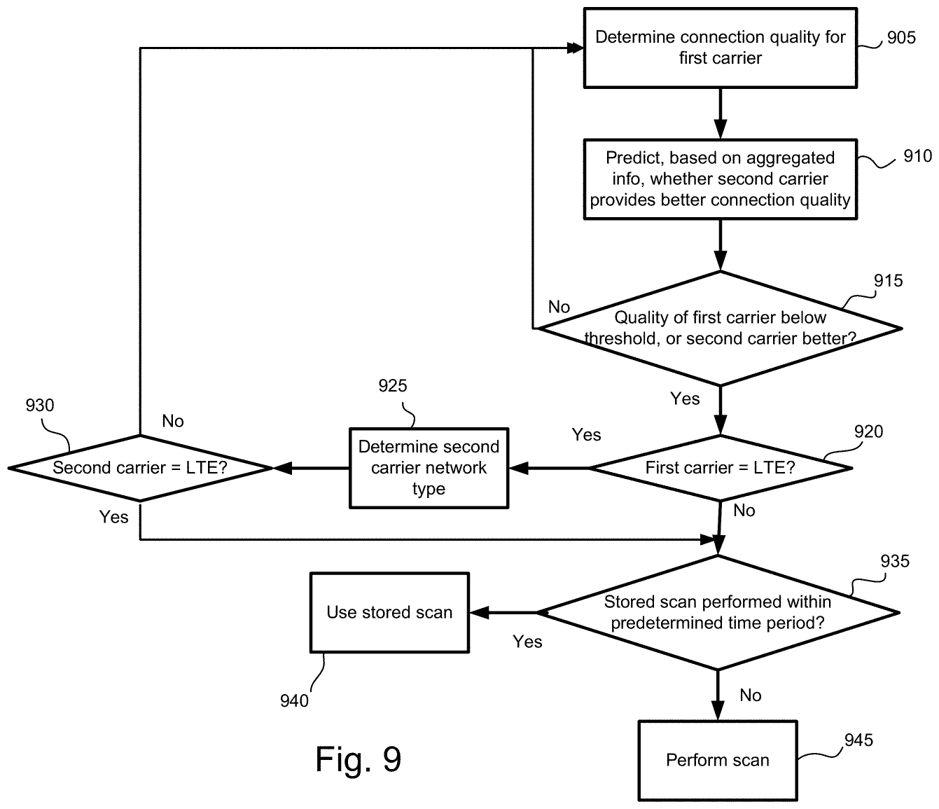

FIG. 9 illustrates an example method of determining when to perform a carrier scan. While the operations of FIG. 9 are described in a particular order, it should be understood that the order may be modified and/or multiple operations may be performed simultaneously. Further, operations may be added or omitted. The method may be performed by, for example, a UE coupled to a first carrier.

In block 905, a connection quality for the first carrier is determined. The connection quality may be determined based on, for example, throughput of applications executed by the UE. Additionally or alternatively, the connection quality may be determined based on signal strength indicators, such as RSRP, RSRQ, bandwidth, frequency, cell connection status, etc.

In block 910, the UE predicts whether a second carrier provides better connection quality. For example, the UE may execute a machine learning algorithm generated by a server based on crowdsourced throughput information.

In block 915, it is determined whether the quality of the first carrier is below a predetermined threshold, and/or the second carrier is predicted to provide better connection quality than the first carrier. If not, the UE may continue to monitor connection quality and look for alternative potential carriers. If yes, the UE further considers a potential carrier scan and switch.

In block 920, the UE determines whether the first carrier over which it is currently communicating has a network type of LTE. For example, the UE may aim to prevent switching from an LTE network to another type of network, as discussed above. Accordingly, if the first carrier is LTE, the UE determined the network type for the second carrier (block 925).

If the second carrier is determined in block 930 not to be an LTE network, the UE may no longer consider a scan or a switch, and may instead continue monitoring for potential better carriers. However, if the second carrier is determined to be LTE, the method proceeds to block 935.

In block 935, it is determined whether the UE stores a scan that was performed within a predetermine time period. For example, if the UE just recently completed a scan within a few seconds, the stored scan may be sufficient. Accordingly, in that scenario, the UE may utilize the stored scan (block 940) in determining whether to switch carriers. However, if there is no scan stored that has been performed within the time period, the UE may decide to perform a new carrier scan (block 945).

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of determining whether to perform a scan of carriers available for connection to a user equipment (UE), the method comprising:
determining a network connection quality for carrier connection between the UE and a first communication carrier;
predicting, based on aggregated throughput information for connections between one or more UEs and a variety of carriers, whether a second carrier has better connection quality than the first communication carrier; and
determining whether to perform a carrier scan based on at least one of the determined connection quality for the first communication carrier and the predicted connection quality for the second carrier.

2. The method of claim 1, wherein the connection quality for the first communication carrier is computed based on at least one of signal strength or throughput of applications executed by the UE over the first communication carrier.

3. The method of claim 1, further comprising:
identifying the second carrier as a target for switching;
identifying a target network type of the second carrier; and
comparing the target network type of the second network to a current network type of the first carrier;
wherein the determining whether to perform the carrier scan is further based on at least one of the target network type or the current network type.

4. The method of claim 1, further comprising scheduling carrier scans to be performed at predetermined intervals.

5. The method of claim 4, wherein the determining whether to perform the carrier scan is further based on timing of a next scheduled scan.

6. The method of claim 5, wherein when the next scheduled scan is scheduled within a predetermined time period, canceling the next scheduled scan and initiating a new scan.

7. The method of claim 1, further comprising:
determining a time at which a most recently stored scan was performed;
wherein the determining whether to perform the carrier scan is further based on the time the most recently stored scan was performed.

8. The method of claim 1, further comprising:
detecting a potential carrier switching action; and
scheduling, by the UE, the network scan before the potential carrier switching action occurs.

9. The method of claim 1, further comprising:
determining whether the determined connection quality for the first connection carrier is below a predetermined threshold; and
requesting the network scan in response to determining that the connection quality is below the predetermined threshold.

10. A system for determining whether to perform a scan of carriers available for connection to a user equipment (UE) , the method comprising:
a memory;
a communication interface; and
one or more processors in communication with the memory and the communication interface, the one or more processors configured to:
determine a network connection quality for a carrier connection between the UE and a first communication carrier;
predict, based on aggregated throughput information for connections between one or more UEs and a variety of carriers, whether a second carrier has better connection quality than the first communication carrier; and
determine whether to perform a carrier scan based on at least one of the determined connection quality for the first communication carrier and the predicted connection quality for the second carrier.

11. The system of claim 10, wherein the connection quality for the first communication carrier is computed based on at least one of signal strength or throughput of applications executed by the UE over the first communication carrier.

12. The system of claim 10, further comprising:
identifying the second carrier as a target for switching;
identifying a target network type of the second carrier; and
comparing the target network type of the second network to a current network type of the first carrier;
wherein the determining whether to perform the carrier scan is further based on at least one of the target network type or the current network type.

13. The system of claim 10, further comprising scheduling carrier scans to be performed at predetermined intervals.

14. The system of claim 13, wherein the determining whether to perform the carrier scan is further based on timing of a next scheduled scan.

15. The system of claim 14, wherein when the next scheduled scan is scheduled within a predetermined time period, canceling the next scheduled scan and initiating a new scan.

16. The system of claim 10, further comprising:
determining a time at which a most recently stored scan was performed;
wherein the determining whether to perform the carrier scan is further based on the time the most recently stored scan was performed.

17. The system of claim 10, further comprising: detecting a potential carrier switching action; and
scheduling, by the UE, the network scan before the potential carrier switching action occurs.

18. The system of claim 10, further comprising:
determining whether the determined connection quality for the first connection carrier is below a predetermined threshold; and
requesting the network scan in response to determining that the connection quality is below the predetermined threshold.

19. A computer-readable medium storing instructions executable by one or more processors for performing a method of determining whether to switch a carrier connection of a user equipment (UE) with a first communication carrier to a second communication carrier, the method comprising:
determining a network connection quality for carrier connection between the UE and a first communication carrier;
predicting, based on aggregated throughput information for connections between one or more UEs and a variety of carriers, whether a second carrier has better connection quality than the first communication carrier; and
determining whether to perform a carrier scan based on at least one of the determined connection quality for the first communication carrier and the predicted connection quality for the second carrier.
